(19) United States
(12) Patent Application Publication
(10) Pub. No.: US 2011/0107642 A1
(43) Pub. Date: May 12, 2011

(54) Long Arm Grip Enhancing Device

(76) Inventor: Michael B. Godard, Melbourne, FL (US)

(21) Appl. No.: 12/615,701

(22) Filed: Nov. 10, 2009

(51) Int. Cl. F41C 23/16; F41C 27/00; F41C 7/00; B32B 37/12

(52) U.S. Cl. 42/71.01; 156/60

(57) ABSTRACT

A long arm grip enhancing device for installation on the front grip portion of the stock on a long arm such as a rifle, a shotgun, a muzzle loader, and the like. The long arm grip enhancing device of the present invention is composed of resiliently deformable material that provides each user with a uniquely customized grip. The present long arm grip enhancing device is usable as an after-market add-on for conventional long arm stocks as well as small arms while the majority of prior art grip enhancement devices are only compatible with small arms such as handguns and pistols that have removable side panels to which the prior art grip enhancement device is secured. The long arm grip enhancing device of the present invention is fully compatible with long arm stocks that are typically of a unitary construction and may be composed of a wide range of materials.

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to firearm grip enhancing devices, more specifically, the present invention relates to devices applied to the front surface of the grip portion on the stock of a long arm. The devices of the present invention are combined and cooperate with the standard grip element of conventional long arms such as rifles, shotguns, muzzle loaders, and the like.

2. Background Art

It has become increasingly popular in the handgun or pistol grip art to utilize grips and grip assemblies composed of rubber or some other relatively soft elastomer for a number of reasons. The use of elastomers in the grip assembly may provide for a better “feel” in the user's hand and may provide a certain amount of bulk or sizing to otherwise standard factory-produced grips. Naturally, the user's shooting control derives from a more comfortable and more consistent way of gripping the gun. The concept of elastomer grips has also resulted in rather complex structures including rigid inserts for reinforcement as well as additional cavities to enhance the shock absorbing ability of the elastomer material.

Modifications and improvements made to small arms grips, such as pistol and handgun grips, typically comprise either full overwrap configurations or partial wrap-around configurations that are secured underneath or otherwise connected with the side panels of a such a handgun. U.S. Pat. No. 3,815,270 to Pachmyer comprises two opposite side sections to be received at opposite sides of the handle and interconnected by a forward portion of the grip. The side sections of the Pachmyer pistol grip contain rigid reinforcing plates and further comprise openings for screws that tightly clamp to the side sections to the handgun's handle.

Similarly, the grip unit in U.S. Pat. No. 5,465,520 to Cupp comprises two side panels that receive two reinforcing plates bonded to two side portions of a forward grip unit. The side panels and any overlaying surfaces may be held in place by screws and/or deformable projections.

U.S. Pat. No. 5,621,997 to Pearce comprises a forward finger rest cushion member molded integral with reduced thickness side wing members which extend rearwardly in full face engagement with the gun handle and beneath the standard side panel grip elements. The side wing panels may be secured beneath the standard side panel grip elements by screws.

U.S. Pat. No. 6,073,381 to Farrar et al. comprises a front finger groove adapter having two tabs that engage the frame of the handgun and two outward mounting arms having mounting holes, wherein the outward mounting arms are secured beneath the standard side panel grips of the handgun.

None of the above patents disclose structural features or advantages capable of use on long arms such as rifles, shotguns, muzzle loaders, and the like. The devices of the prior art utilize screws or otherwise mateable connections to secure some manner of side wing or panel atop or beneath the original side panels of a handgun. The stocks of conventional long arms typically are of unitary construction thereby not comprising removable side panels as shown with conventional small arm handguns and pistols within the prior art. Without removable side panels the stocks of long arms do not typically comprise connectors or screw holes into which a full or partial wrap-around configuration may be secured. Thus, the grip enhancements and solutions disclosed in the prior art pertaining to small arms such as pistols and handguns are not applicable or are not able to be incorporated onto conventional long arms.

The long arm grip enhancing device of the present invention provides a grip enhancing device that may easily be affixed to the front grip panel of a conventional stock on a long arm. The axis of a grip portion on a conventional long arm is typically much closer to horizontal and parallel with the ground whereas the axis of a conventional handgun or small arm grip is typically much closer to vertical or disposed perpendicular to the ground. A user of a long arm would greatly benefit in incorporating a resilient gripping surface on the front surface of the grip portion of their long arm. While the butt of a conventional stock assists a user in maintaining control of a long arm while firing ammunition, the additional use of the grip enhancing device of the present invention allows a user's trigger hand to further assist in stabilizing and absorbing the recoil force while shooting a long arm. The present invention provides the user's trigger hand with a uniquely customized grip that is specific to the anatomy of the specific user's hand and the resilient nature of the grip enhancement device further provides the user with a stronger grip about the stock of the long arm.

The grip enhancing device of the present invention is designed to provide a single unitary element that may be used as an after-market attachment which cooperates with and may be easily retained on the stock of conventional long arms known within the art.

The grip enhancing device of the present invention is also designed to provide a single unitary element that may be used as an after-market attachment which cooperates with and may be easily retained on the forward grip surface of conventional small arms known within the art.

It is further an aspect of this invention to provide a grip enhancing device that is comfortably usable by the widest possible range of users since the resilient nature of the grip enhancing device provides for a user-specific grip.

It is also an aspect of this invention to provide a deformable grip enhancing device that would provide more comfort and shooting control by users with different hand and finger sizes and shapes.

### BRIEF SUMMARY OF THE INVENTION

In accordance with one embodiment, a long arm grip enhancing device for the front grip portion of a stock on a long arm, comprising a resiliently deformable elongated body having a central axis terminating at a first end and a second end, wherein the resiliently deformable elongated body further comprises an upper contact surface, and a lower attachment surface, a first attachment arm in communication with and disposed parallel to the resiliently deformable body, a second attachment arm in communication with and disposed parallel to the resiliently deformable body, the first and second attachment arms disposed along opposing sides of the central axis of the resiliently deformable elongated body, and an adhesive layer affixed to the lower attachment surface of the resiliently deformable elongated body, wherein the adhesive layer is adapted to affix the grip enhancing device to the front grip portion of the stock on the long arm.

In accordance with another embodiment of the present invention, a grip enhancing device for the front grip portion of a firearm, comprising a resiliently deformable elongated body having a central axis terminating at a first end and a second end, wherein the resiliently deformable elongated body further comprises an upper contact surface, and a lower attachment surface, wherein the resiliently deformable elongated body comprises a visco-elastic thermoset, polyether-based, polyurethane material, a first attachment arm in communication with and disposed parallel to the resiliently deformable body, a second attachment arm in communication with and disposed parallel to the resiliently deformable body, the first and second attachment arms disposed along opposing sides of the central axis of the resiliently deformable elongated body, wherein the first attachment arm and the second attachment arm each respectively comprise a tapering thickness, wherein a thickest portion is disposed proximal to the central axis of the resiliently deformable elongated body and a thinnest portion is disposed distal to the central axis of the resiliently deformable elongated body, and an adhesive layer affixed to the lower attachment surface of the resiliently deformable elongated body, wherein the adhesive layer is adapted to affix the grip enhancing device to the front grip portion of the firearm.

In accordance with still another embodiment of the present invention, a method of installing a long arm grip enhancing device on the front grip portion of a stock on a long arm, the method comprising the steps of providing the long arm grip enhancing device, comprising a resiliently deformable elongated body having a central axis terminating at a first end and a second end, wherein the resiliently deformable elongated body further comprises an upper contact surface, and a lower attachment surface, a first attachment arm in communication with and disposed parallel to the resiliently deformable body, a second attachment arm in communication with and disposed parallel to the resiliently deformable body, the first and second attachment arms disposed along opposing sides of the central axis of the resiliently deformable elongated body, and an adhesive layer affixed to the lower attachment surface of the resiliently deformable elongated body, wherein the adhesive layer is adapted to affix the grip enhancing device to the front grip portion of the stock on the long arm; positioning the long arm grip enhancing device above the front grip portion of the long arm, wherein the central axis of the resiliently deformable elongated body is parallel to the front grip portion of the stock on the long arm; and compressing the long arm grip enhancing device against the front grip portion of the stock on the long arm, wherein the adhesive layer secures to the front grip portion of the stock on the long arm.

### BRIEF DESCRIPTION OF THE DRAWINGS

FIG. 1 depicts an exemplary prior art handgun grip enhancer disclosed in U.S. Pat. No. 5,621,997 issued to Pearce.

FIG. 2A depicts a simplified side view of a conventional straight grip stock.

FIG. 2B depicts a simplified side view of a conventional semi-pistol grip stock.

FIG. 3 depicts a perspective view of a universal embodiment of the grip enhancing device of the present invention.

FIG. 4 depicts a side view of the universal embodiment of the grip enhancing device shown in FIG. 3.

FIG. 5 depicts an end view of the universal embodiment of the grip enhancing device shown in FIG. 3.

FIG. 6 depicts a top view of the universal embodiment of the grip enhancing device shown in FIG. 3.

FIG. 7 depicts a perspective view of a finger grip embodiment of the grip enhancing device of the present invention.

FIG. 8 depicts a side view of the finger grip embodiment of the grip enhancing device shown in FIG. 7.

FIG. 9 depicts an end view of the finger grip embodiment of the grip enhancing device shown in FIG. 7.

FIG. 10 depicts a top view of the finger grip embodiment of the grip enhancing device shown in FIG. 7.

FIG. 11 depicts a perspective view of another universal embodiment of the grip enhancing device of the present invention.

FIG. 12 depicts a side view of the embodiment of the grip enhancing device shown in FIG. 11.

FIG. 13 depicts an end view of the embodiment of the grip enhancing device shown in FIG. 11.

FIG. 14 depicts a top view of the embodiment of the grip enhancing device shown in FIG. 11.

FIG. 15 depicts a perspective view of another universal embodiment of the grip enhancing device of the present invention.

FIG. 16 depicts a side view of the embodiment of the grip enhancing device shown in FIG. 15.

FIG. 17 depicts an end view of the embodiment of the grip enhancing device shown in FIG. 15.

FIG. 18 depicts a top view of the embodiment of the grip enhancing device shown in FIG. 15.

FIG. 19 depicts a perspective view of another finger grip embodiment of the grip enhancing device of the present invention.

FIG. 20 depicts a side view of the finger grip embodiment of the grip enhancing device shown in FIG. 19.

FIG. 21 depicts an end view of the finger grip embodiment of the grip enhancing device shown in FIG. 19.

FIG. 22 depicts a top view of the finger grip embodiment of the grip enhancing device shown in FIG. 19.

FIG. 23 depicts a side view of the universal embodiment of the grip enhancing device shown in FIGS. 3-6 placed on the front grip portion of a conventional rifle.

FIG. 24 depicts a side view of the finger grip embodiment of the grip enhancing device shown in FIGS. 7-10 placed on the front grip portion of a conventional shotgun.

FIG. 25 depicts a side view of the finger grip embodiment of the grip enhancing device shown in FIGS. 19-22 placed on the front grip portion of a conventional muzzle loader.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

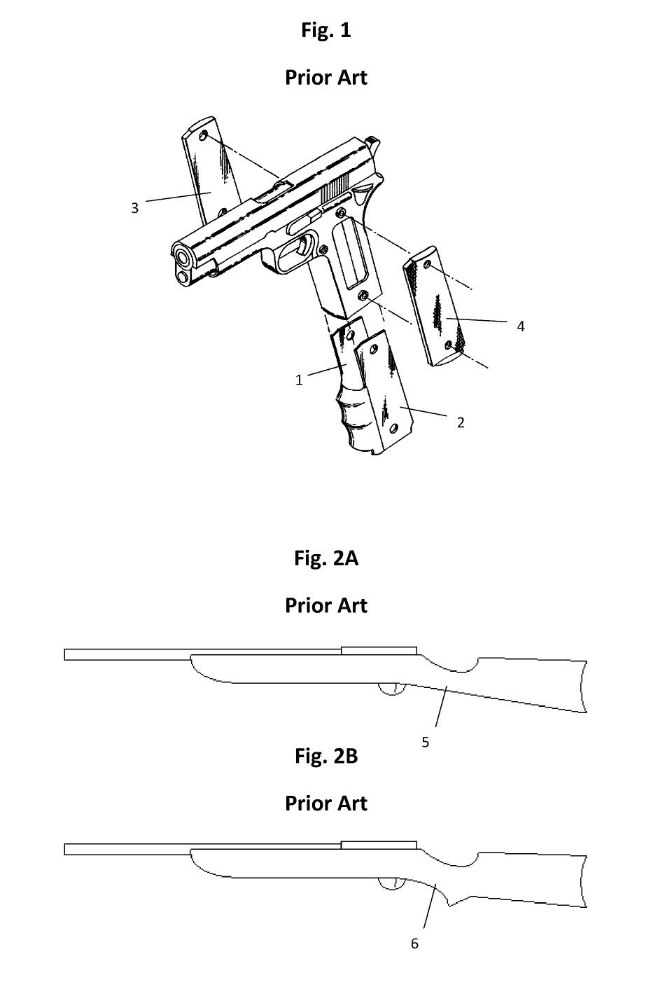

Referring now to the drawings, FIG. 1 from U.S. Pat. No. 5,621,997 issued to Pearce is generally illustrative of prior art attempts to improve the grips on small arms such as pistols or handguns. The Pearce small arm grip enhancer comprises left and right wing members 1,2 that form side plates that are secured beneath the standard side panel grips 3,4 of the handgun or pistol. While useful for its specific purpose on pistols and handguns, small arm grip enhancing products that required fixation via the removable standard side panels of conventional small arms eliminate or prevent the possibility of such prior art devices being used on any conventional long arms or any other firearms having a unitary stock and/or grip portion.

Conventional long arms are firearms that possess longer barrels than the other classes of firearms and such long arms are traditionally braced against the shooter's shoulder for support. Long arms may generally include but are not limited to rifles, shotguns, muskets, other muzzle loaders, and the like. A shoulder stock is generally used to assist in both stabilizing the gun and absorbing recoil after firing. A majority of long arm stocks may provide the user with either a straight grip or a semi-pistol grip. FIG. 2A illustrates a simplified example of a straight grip stock 5 that is smoothly contoured from the toe of the stock to the trigger. FIG. 2B illustrates a simplified example of a semi-pistol grip stock 6 that is very common and has a steeper angle cut into the stock to provide a more diagonal angle for the trigger hand. Modern stocks are trending toward a more vertical full pistol grip configuration and many variations of such stocks are known in the art. Conventional long arm stock materials may include but are not limited to wood and laminated wood; metals; injection molded synthetic materials such as thermoplastic materials; hand-laid composite materials including but not limited to fiberglass, Kevlar, Carbolite, Fiberthane, Zytel nylon, carbon fiber, urethane foam, graphite cloth and an appropriate binder; and the like.

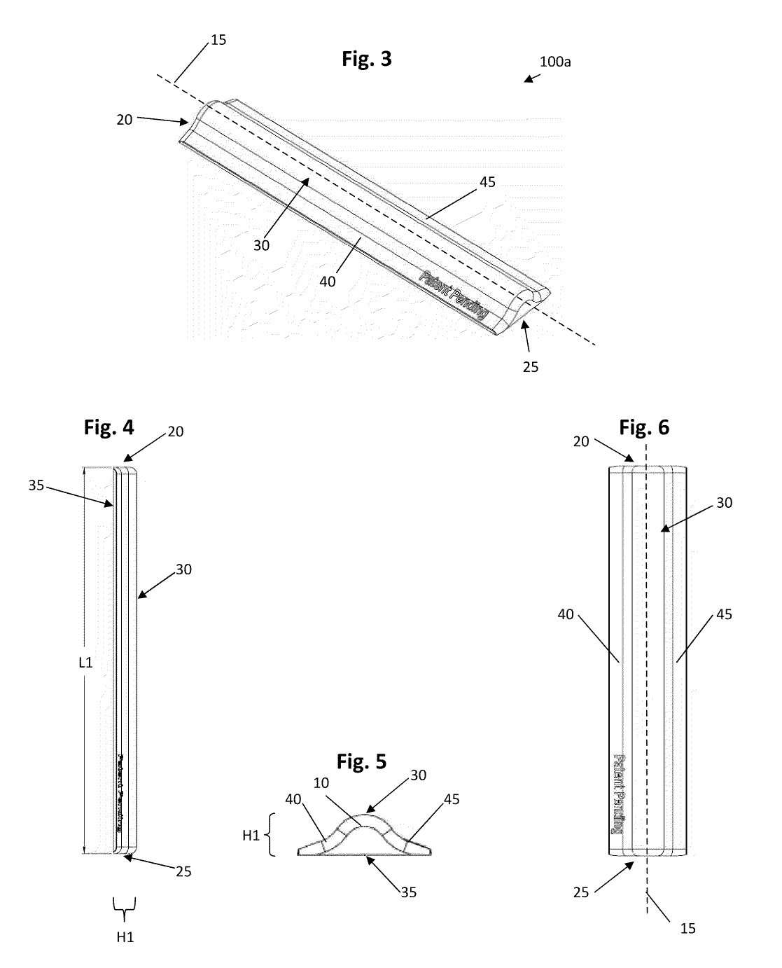

In order to solve the problems regarding the inability of applying prior art handgun grip enhancing products to conventional long arms, the present invention discloses a long arm grip enhancing device, as shown throughout FIGS. 3-25, that is securable to only the front grip portion of the stock of a long arm. In this manner the present inventive grip enhancing device may be used in conjunction with conventional long arms and any other weapons having a unitary stock and/or unitary grip component. The long arm grip enhancing device may be formed of a resiliently deformable or elastomeric material such as soft neoprene or other rubber compounds known within the gun grip arts. In a preferred embodiment, the long arm grip enhancing device comprises a visco-elastic thermoset, polyether-based, polyurethane material such as that marketed under the trademark Sorbothane and sold by Sorbothane, Inc. of Ohio.

One embodiment of the long arm grip enhancing device 100 is illustrated in FIGS. 3-6. In such a universal configuration 100a no finger grooves are present thus allowing each user's hand to provide a fully unique and customized grip due to the specific pressure points of the user's fingers. In this manner, the sizing of finger grooves in other embodiments is irrelevant and cannot cause a poor or uncomfortable grip shape for users having either oversized or undersized hands that are not accommodated properly when using a pre-sized finger groove configuration.

As shown in FIGS. 3-6, a universal configuration 100a may comprise a resiliently deformable elongate body 10 that extends along a central axis 15 and terminates at a first end 20 and a second end 25. The elongate body 10 further comprises an upper contact surface 30 for contacting a user's trigger hand fingers during use wherein the upper contact surface 30 is parallel to the central axis 15. A lower attachment surface 35 provides for a point of contact between the front grip portion of the stock of a conventional long arm and the long arm grip enhancing device 100 of the present invention. A first attachment arm 40 and a second attachment arm 45 are in communication with the elongate body 10 and are disposed parallel to the central axis 15. Each of the first and second attachment arms 40,45 may comprise a tapering height or thickness wherein a thickest portion is disposed proximal to the central axis 15 and a thinnest portion is disposed distal to the central axis 15. In such a configuration, the height or thickness of the first attachment arm 40 and the second attachment arm 45 diminishes as the respective structures extend radially away from the central axis 15 of the elongate body 10.

An adhesive layer may be applied onto the lower attachment surface 35 of the resiliently deformable elongate body 10 to provide for fixation between the device 100 of the present invention and the stock of a long arm. A wide range of known adhesives may be capable of use, wherein the selection of an appropriate adhesive may be dependent on the adhesive's compatibility with both the material of the elongate body 10 and/or the material of the long arm stock. Adhesives may include but are not limited to solvent-based one-part polyurethane adhesive such as adhesive #7650 sold by Lord Corporation of North Carolina; two part polyurethane adhesives such as adhesive #7542A/B sold by Lord Corporation; neoprene-based adhesives; both flexible and rigid cyanoacrylates such as those sold under the trademarks Crazy Glue and Super Glue and further including adhesives 401, 409, 447, 454, 4851, and 4861 sold by Henkel Loctite Corporation of Rocky Hill, Conn. and adhesive 7700 sold by Lord Corporation; Duco cements such as those sold by ITW Devon of Danvers, Mass.; and metal primers such as that sold under the trademark Chemlok 213 by Lord Corporation. This is just a partial and exemplary list of potential adhesives of the present invention wherein the scope of the present invention further includes any other adhesives known within the art.

One or more removable tabs may be disposed or affixed over the adhesive layer that is applied to the lower attachment surface 35. The one or more removable tabs protect the adhesive layer from adhering with any non-selected surfaces. Removal or “peeling away” of the one or more removable tabs is required before at least a portion of the adhesive layer is exposed and the grip enhancing device 100 is ready to be installed on a selected surface. The function and removal of the one or more removable tabs is highly analogous to the removable tabs found on the underside of conventional bandages sold under the trademark Band-Aids. Protective tab(s) facilitate the shipping, handling, processing, sales, and pre-installation of the long arm grip enhancing device 100 of the present invention. After removal of the one or more tabs, the long arm grip enhancing device 100 is ready for installation on the front grip portion of a long arm.

Another embodiment of the long arm grip enhancing device 100 is illustrated in FIGS. 7-10. Such a finger grip configuration 100b is highly analogous to the universal configuration 100a described and illustrated in FIGS. 3-6; however, the upper contact surface 30 of the two embodiments provides for the main point of distinction. Like structures shared between embodiments have the same reference numeral designation throughout the present description. In a finger grip configuration 100b the upper contact surface 30 comprises a plurality of finger grip surfaces contoured for receiving the fingers of a user's trigger hand. Adjacent finger grip surfaces may be separated by one of a plurality of finger grip ridges. The plurality of finger grip surfaces are intended to seat the middle, ring and little fingers, for example, of the user's hand when the user is gripping a long arm with the present grip enhancing device 100 installed.

As shown in FIGS. 7-10, a finger grip configuration 100b may comprise a resiliently deformable elongate body 10 that extends along a central axis 15 and terminates at a first end 20 and a second end 25. The elongate body 10 further comprises an upper contact surface 30 for contacting a user's trigger hand fingers during use. In a preferred embodiment as shown in FIGS. 7-10, the upper contact surface 30 may further comprise three finger grip surfaces depicted as a first outer finger grip surface 50, a central finger grip surface 55, and a second outer finger grip surface 60. The three finger grip surfaces may be separated by a first finger grip ridge 65 and a second finger grip ridge 70. A lower attachment surface 35 provides for a point of contact between the front grip portion of the stock of a conventional long arm and the long arm grip enhancing device 100 of the present invention. A first attachment arm 40 and a second attachment arm 45 are in communication with the elongate body 10 and are disposed parallel to the central axis 15. Each of the first and second attachment arms 40,45 may comprise a tapering height or thickness wherein a thickest portion is disposed proximal to the central axis 15 and a thinnest portion is disposed distal to the central axis 15. In such a configuration, the height or thickness of first attachment arm 40 and second attachment arm 45 diminishes as the respective structures extend radially away from the central axis 15 of the elongate body 10.

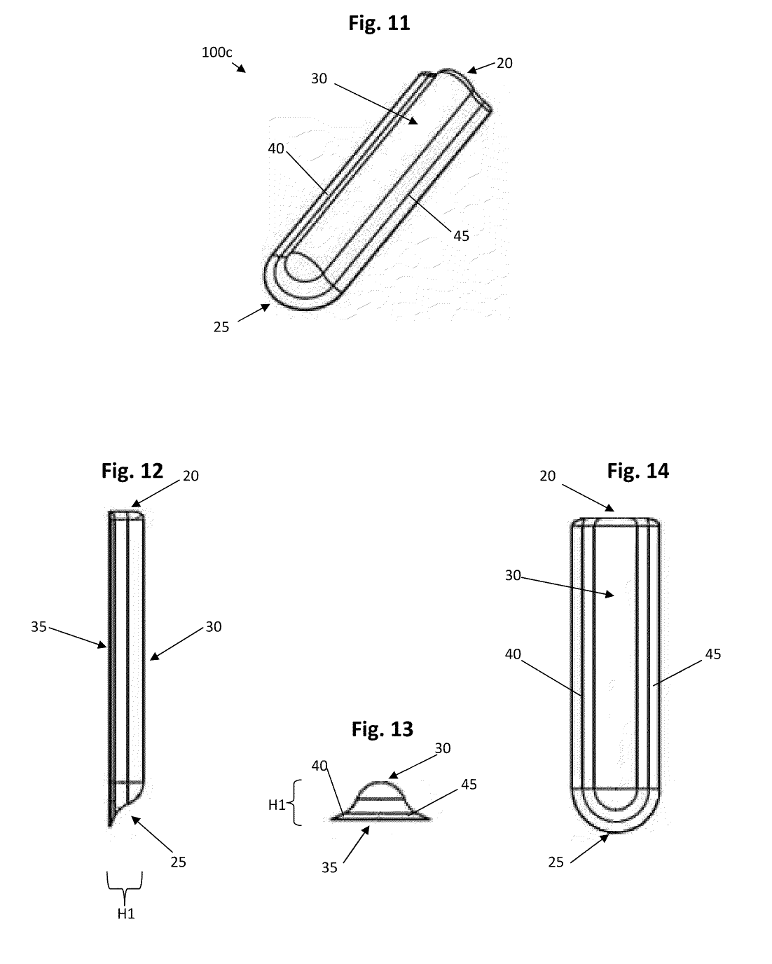

The long arm grip enhancing device 100 of the present invention may include several variations, one of which is generally depicted in FIGS. 11-14. The embodiment shown comprises a universal configuration 100c wherein the first end 20 is flat and truncated relative to the second end 25 that is rounded off and comprises a tapering height or thickness as best shown in the side view of FIG. 12. In preferred embodiments of the present invention both the first end 20 and the second end 25 are flat and truncated allowing a user to further trim the grip enhancing device 100 to an appropriate length to fit the particular front grip portion of a specific long arm. Alternatively, only one side may be trimmed to provide both a proper fit and one rounded or tapered end. Preferably, the grip enhancing device 100 of the present invention is sized to extend from the trigger guard to the butt or end of the grip portion on the stock of the long arm. The scope of the present invention includes but is not limited to a first end 20 and a second end 25 that may be independently configured in a flat, rounded, and/or tapering configuration.

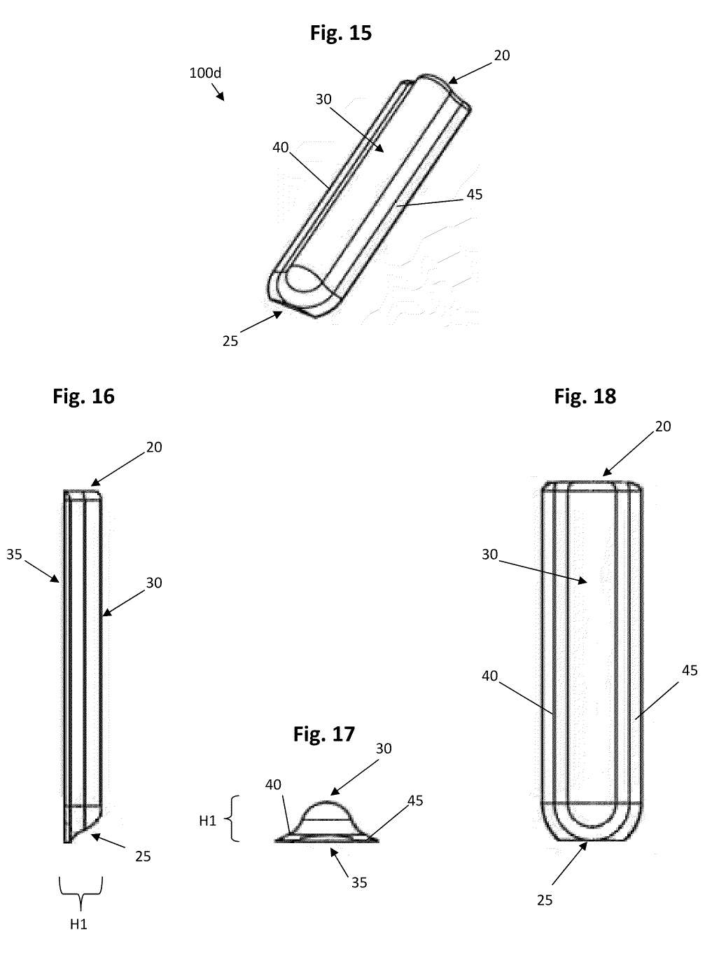

FIGS. 15-18 illustrate still another embodiment of a universal configuration 100d. This embodiment is highly similar to the configuration 100c shown in FIGS. 11-14. One variation present in the configuration 100d of FIGS. 15-18 is the truncated second end 25 of the device. The embodiment shown comprises a first end 20 is flat and squared-off relative to the second end 25 that is rounded off and comprises a tapering height or thickness that has a truncated tip as best shown in FIGS. 15 and 18. Such a universal configuration 100d provides an alternate variation of the device 100 for a user to attach to their firearm. Alternately, the user may trim and thus truncate the second end 25 of a device having a universal configuration 100c shown in FIGS. 11-14 to create the alternate embodiment exemplified in the universal configuration 100d shown in FIGS. 15-18.

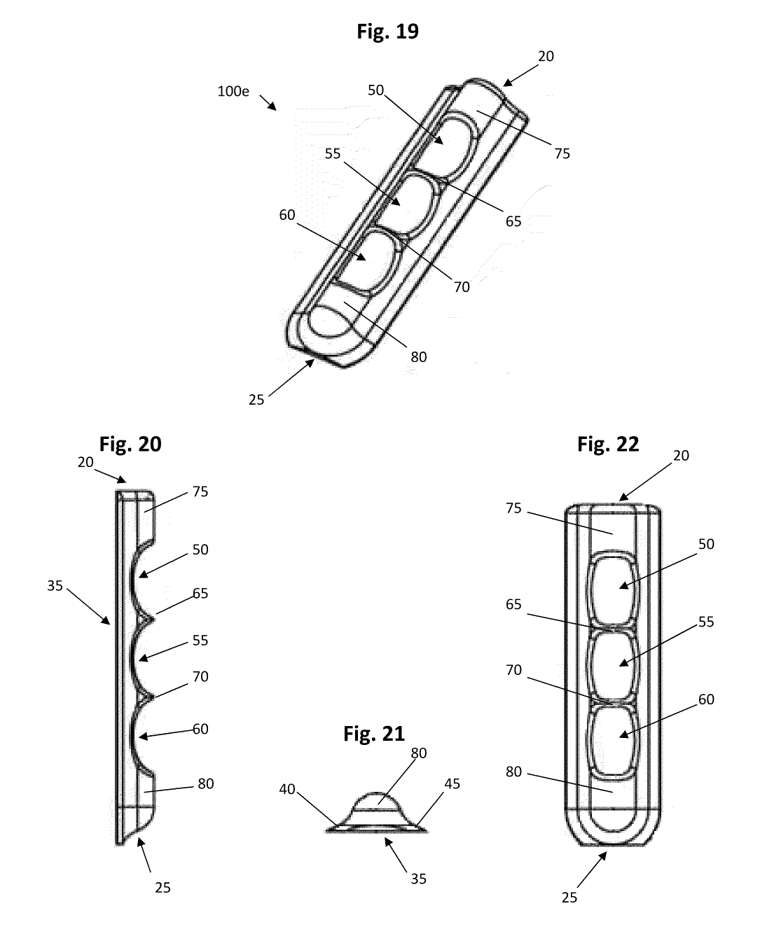

Many variations and alternate embodiments of the finger grip configuration are also within the scope of the present invention. FIGS. 19-22 illustrate another finger grip configuration 100e that is similar to the finger grip configuration 100b depicted in FIGS. 7-10. Finger grip configuration 100e may comprise a squared-off first end 20 that is suitable to be trimmed and a tapered and rounded second end 25 that may comprise a truncated tip. Another point of distinction between the configurations is shown by first end portion 75 at the first end 20 and a second end portion 80 at the second end 25 comprising a height or thickness approximately equal to that of the first and second finger grip ridges 65,70. The height or thickness of the first and second end portions 75,80 is greater that the height or thickness of each of the first outer finger grip surface 50, the central finger grip surface 55, and the second outer finger grip surface 60. The configuration 100e of FIGS. 19-22 may provide for greater ease in the seating of a user's middle finger and the little finger into the first and second outer finger grip surfaces 50,60 respectively.

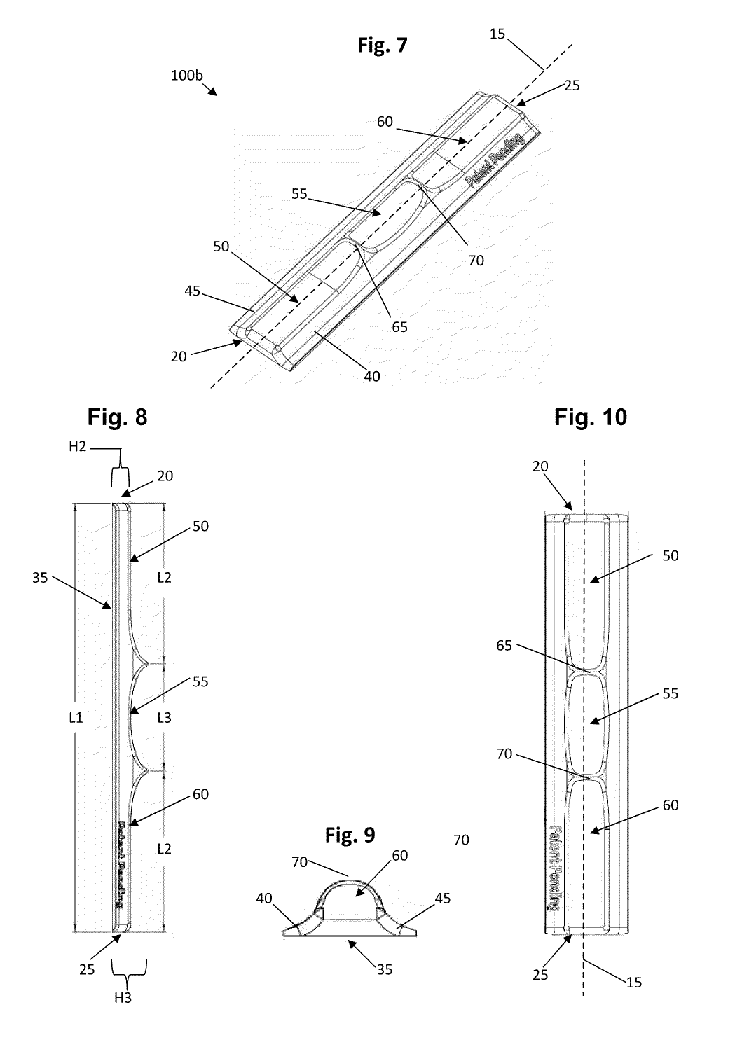

The embodiments of the long arm grip enhancing device 100 of the present invention may be scaled up or down as needed by the user. Additionally, the first end 20, second end 25, first attachment arm 40, and second attachment arm 45 may either collectively or independently be cut or trimmed to provide any size grip enhancing device 100 as need for a particular long arm. In a preferred embodiment, but not a limiting embodiment, the present invention may comprise an overall length L in the range between two inches and seven inches (see FIG. 4 and FIG. 8). In a more preferred embodiment, the overall length L is the range between three inches and six inches. In a most preferred embodiment, the overall length L of the present invention is five inches.

In a preferred embodiment of the universal configuration 100a shown in FIGS. 3-6 and FIGS. 11-14, the upper contact surface 30 of the present invention comprises a height H1 in the range between 0.10 inches and 1.00 inches (see FIG. 4 and FIG. 12). In a more preferred embodiment, the upper contact surface 30 of the present invention comprises a height H1 in the range between 0.25 inches and 0.75 inches. In a most preferred embodiment, the overall height H1 of the upper contact surface 30 in the universal configuration 100a is 0.30 inches.

In a preferred embodiment of the finger grip configuration 100b shown in FIGS. 7-10, the plurality of finger grip surfaces comprises a minimal height H2 in the range between 0.10 inches and 0.50 inches; wherein in a more preferred embodiment the plurality of finger grip surfaces comprises a minimal height H2 of 0.21 inches. Similarly, in a preferred embodiment the plurality of finger grip ridges comprise a height H3 in the range between 0.20 inches and 0.75 inches; wherein in a more preferred embodiment the plurality of finger grip ridges comprise a height H3 of 0.42 inches (see FIG. 8).

Additionally, the first outer finger grip surface 50 and the second outer finger grip surface 60 may comprise a respective length L2 in the range between 1.00 inches and 3.00 inches; wherein in a more preferred embodiment the first outer finger grip surface 50 and the second outer finger grip surface 60 may comprise a respective length L2 in the range between 1.75 inches and 2.00 inches (see FIG. 8). In a most preferred embodiment, the respective length L2 of the first outer finger grip surface 50 and the second outer finger grip surface 60 is 1.875 inches. Similarly, the central finger grip surface 55 may comprise a respective length L3 in the range between 0.50 inches and 2.00 inches; wherein in a more preferred embodiment the central finger grip surface 55 may comprise a respective length L3 in the range between one inch and 1.50 inches (see FIG. 8). In a most preferred embodiment, the length L3 of the central finger grip surface 55 is 1.25 inches.

Long arm grip enhancing devices 100 of the present invention may be manufactured in various hardness levels that may be determined on different scales known within the art including but not limited to the Shore 00 scale and the Shore A scale. In a preferred embodiment, the resiliently deformable or elastomeric material of the grip enhancing device 100 of the present invention comprises a Shore hardness on the Shore 00 scale between 0 and 99; wherein in a more preferred embodiment the resiliently deformable or elastomeric material of the grip enhancing device 100 of the present invention comprises a Shore hardness on the Shore 00 scale between 20 and 100. In a most preferred embodiment, the resiliently deformable or elastomeric material comprises a Shore hardness of 30 on the Shore 00 scale. Alternatively, in a preferred embodiment, the resiliently deformable or elastomeric material of the grip enhancing device 100 of the present invention may comprise a Shore hardness on the Shore A scale between 0 and 99; wherein in a more preferred embodiment the resiliently deformable or elastomeric material of the grip enhancing device 100 of the present invention comprises a Shore hardness on the Shore A scale between 20 and 100. In a most preferred embodiment, the resiliently deformable or elastomeric material comprises a Shore hardness of 30 on the Shore A scale. The hardness level may be varied depending on the overall height of structures of the grip enhancing device 100, the user's hand/finger size, and/or the user's preference for resiliency within the firearm grip.

Optionally, the upper contact surface 30 and/or the first and second attachment arms 40,45 of any embodiment of the present invention may be provided with “checkering” or other irregularities to facilitate effective grasping of the long arm grip enhancing device 100 while in use. Also, the upper contact surface 30 may be provided in a wide array of color options or color schemes to please the user and provide an aesthetic accessory for their gun grip.

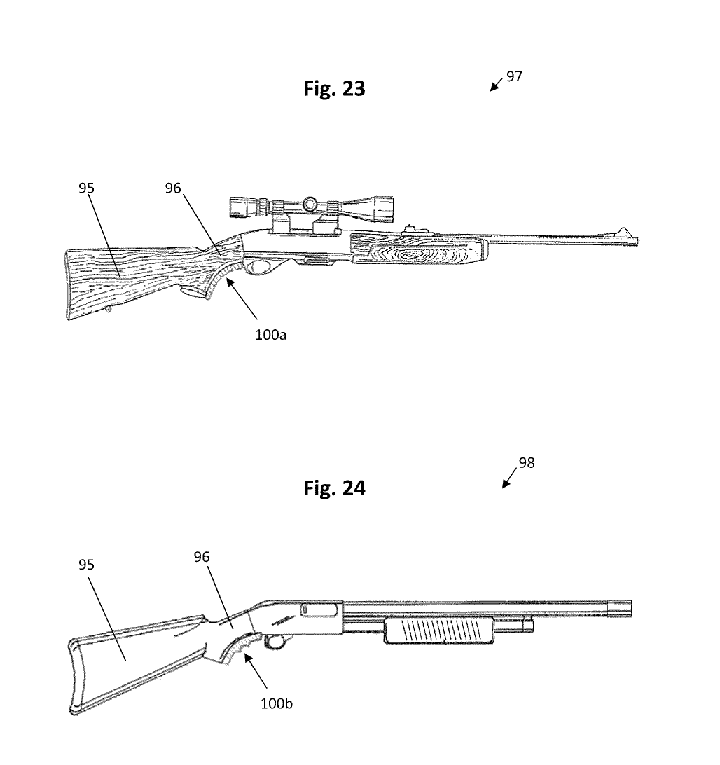

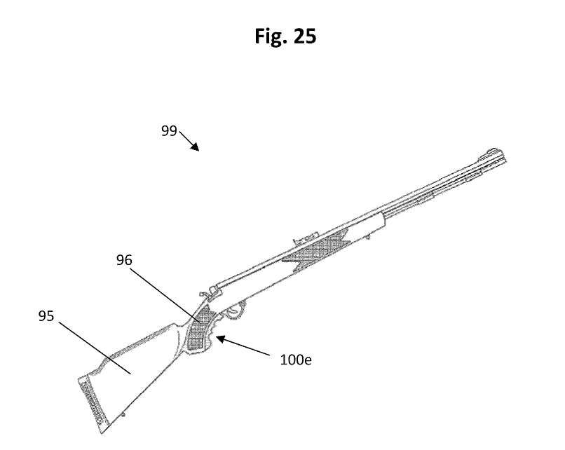

In use, FIG. 23 depicts the completed installation of a universal embodiment 100a of the present invention on the front surface of the grip portion 96 on the stock 95 of a conventional rifle 97. FIG. 24 depicts the completed installation of a finger grip embodiment 100b of the present invention on the front surface of the grip portion 96 on the stock 95 of a conventional shotgun 98. FIG. 25 depicts the completed installation of a second style of a finger grip embodiment 100e of the present invention on the front surface of the grip portion 96 on the stock 95 of a conventional muzzle loader 99.

Installation of the long arm grip enhancing device 100 of the present invention is both quick and easy. A user must first acquire or have provided a long arm grip enhancing device 100 of the present invention and a long arm or other firearm having a unitary stock or grip portion. The grip enhancing device 100 may be positioned above and in close proximity to the front of the grip portion 96 of a long arm such as a rifle 97, shotgun 98, or muzzle loader 99. The grip enhancing device 100 may then be compressed onto the front surface of the grip portion 96 of the long arm wherein the adhesive layer acts to secure the grip enhancing device 100 to the front surface of the grip portion 96. Thereafter, the user will be provided with a resiliently deformable grip that will conform to the unique finger size and finger pressure of each respective user of the firearm. The grip enhancing device 100 of the present invention provides a customized grip for each user that improves comfort and allows for greater control of the firearm when in use.

Additionally, if the grip enhancing device 100 further comprises one or more removable tabs removably disposed or affixed to the adhesive layer, the one or more tabs may be removed from the adhesive layer either before or after the individual performing the installation positions the grip enhancing device 100 above or in close proximity to the front surface of the grip portion 96 of the selected firearm. The one or more removable tabs protect the adhesive layer prior to the installation of the long arm grip enhancing device 100 of the present invention.

The present invention allows users of long arms and other firearms having unitary grips to augment the front surface of the grip portion of their gun, wherein prior art solutions were not applicable to long arms due to the methods of attaching prior art grip enhancers to removable side panels or other small arm structures. While the present invention expands the use of gun grips to long arms and other similar firearms, the present invention may further be used with small arms such as handguns and pistols. The scope of the present invention includes use of the grip enhancing device 100 on both long arms and small arm firearms, while the devices of the prior art are restricted to use only on small arms. The unique structure and method of attachment allows the present grip enhancing device 100 to be used across all product categories and provide a single solution for customized gun grips for both long arms and small arms.

Accordingly the reader will see that, according to the embodiments of the invention, the present invention provides for a uniquely configured long arm grip enhancing device that solves the problems encountered with prior art small arm grip enhancers associated with handguns and pistols. The present invention allows users of long arms and other firearm weapons comprising unitary stocks or grips to install an after-market grip enhancing device to provide for greater comfort, stability, and accuracy when using a firearm having the present invention installed thereon.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the specific examples given.

What is claimed is:

1. A long arm grip enhancing device for the front grip portion of a stock on a long arm, comprising:
a resiliently deformable elongated body having a central axis terminating at a first end and a second end, wherein said resiliently deformable elongated body further comprises an upper contact surface, and a lower attachment surface;
a first attachment arm in communication with and disposed parallel to said resiliently deformable body;
a second attachment arm in communication with and disposed parallel to said resiliently deformable body, said first and second attachment arms disposed along opposing sides of said central axis of said resiliently deformable elongated body; and
an adhesive layer affixed to said lower attachment surface of said resiliently deformable elongated body;
wherein said adhesive layer is adapted to affix said grip enhancing device to said front grip portion of said stock on said long arm.

2. The long arm grip enhancing device of claim 1, wherein said upper contact surface comprises a universal configuration wherein said upper contact surface is parallel with said central axis of said resiliently deformable elongated body.

3. The long arm grip enhancing device of claim 1, wherein said upper contact surface comprises a finger grip configuration wherein said upper contact surface comprises a plurality of finger grip surfaces and a plurality of finger grip ridges.

4. The long arm grip enhancing device of claim 3, wherein said plurality of finger grip surfaces comprises three finger grip surfaces and said plurality of finger grip ridges comprises two finger grip ridges.

5. The long arm grip enhancing device of claim 1, wherein said resiliently deformable elongated body comprises a visco-elastic thermoset, polyether-based, polyurethane material.

6. The long arm grip enhancing device of claim 1, wherein said long arm grip enhancing device comprises a length in the range between two inches and seven inches.

7. The long arm grip enhancing device of claim 6, wherein said long arm grip enhancing device comprises a length in the range between three inches and six inches.

8. The long arm grip enhancing device of claim 2, wherein said upper contact surface of said resiliently deformable elongate body comprises a height in the range between 0.10 inches and 1.00 inches.

9. The long arm grip enhancing device of claim 8, wherein said upper contact surface of said resiliently deformable elongate body comprises a height in the range between 0.25 inches and 0.75 inches.

10. The long arm grip enhancing device of claim 1, wherein said long arm grip enhancing device comprises a Shore hardness on the Shore 00 scale between 20 and 100.

11. The long arm grip enhancing device of claim 10, wherein said Shore hardness of said long arm grip enhancing device is 30.

12. The long arm grip enhancing device of claim 4, wherein said three finger grip surfaces have a height in the range between 0.10 inches and 0.50 inches and said two finger grip ridges have a height in the range between 0.20 inches and 0.75 inches.

13. The long arm grip enhancing device of claim 4, wherein said three finger grip surfaces comprises a first outer finger grip surface and a second outer finger grip surface each having a length in the range between 1.00 inches and 3.00 inches and a central finger grip surface having a length in the range between 0.50 inches and 2.00 inches.

14. The long arm grip enhancing device of claim 1, wherein said first attachment arm and said second attachment arm each respectively comprise a tapering thickness, wherein a thickest portion is disposed proximal to said central axis of said resiliently deformable elongated body and a thinnest portion is disposed distal to said central axis of said resiliently deformable elongated body.

15. The long arm grip enhancing device of claim 1, further comprising:
one or more tabs removably affixed to said adhesive layer, wherein said one or more removable tabs are removed from said adhesive layer before said long arm grip enhancing device is disposed on said front grip portion of said stock on said long arm.

16. A grip enhancing device for the front grip portion of a firearm, comprising:
a resiliently deformable elongated body having a central axis terminating at a first end and a second end, wherein said resiliently deformable elongated body further comprises an upper contact surface, and a lower attachment surface, wherein said resiliently deformable elongated body comprises a visco-elastic thermoset, polyether-based, polyurethane material;
a first attachment arm in communication with and disposed parallel to said resiliently deformable body;
a second attachment arm in communication with and disposed parallel to said resiliently deformable body, said first and second attachment arms disposed along opposing sides of said central axis of said resiliently deformable elongated body, wherein said first attachment arm and said second attachment arm each respectively comprise a tapering thickness, wherein a thickest portion is disposed proximal to said central axis of said resiliently deformable elongated body and a thinnest portion is disposed distal to said central axis of said resiliently deformable elongated body; and
an adhesive layer affixed to said lower attachment surface of said resiliently deformable elongated body;
wherein said adhesive layer is adapted to affix said grip enhancing device to said front grip portion of said firearm.

17. A method of installing a long arm grip enhancing device on the front grip portion of a stock on a long arm, said method comprising the steps of:
providing said long arm grip enhancing device, comprising:
a resiliently deformable elongated body having a central axis terminating at a first end and a second end, wherein said resiliently deformable elongated body further comprises an upper contact surface, and a lower attachment surface;
a first attachment arm in communication with and disposed parallel to said resiliently deformable body;
a second attachment arm in communication with and disposed parallel to said resiliently deformable body, said first and second attachment arms disposed along opposing sides of said central axis of said resiliently deformable elongated body; and
an adhesive layer affixed to said lower attachment surface of said resiliently deformable elongated body;
wherein said adhesive layer is adapted to affix said grip enhancing device to said front grip portion of said stock on said long arm;
positioning said long arm grip enhancing device above said front grip portion of said long arm, wherein said central axis of said resiliently deformable elongated body is parallel to said front grip portion of said stock on said long arm; and
compressing said long arm grip enhancing device against said front grip portion of said stock on said long arm, wherein said adhesive layer secures to said front grip portion of said stock on said long arm.

18. The method of claim 17, wherein said resiliently deformable elongated body comprises a visco-elastic thermoset, polyether-based, polyurethane material.

19. The method of claim 17, wherein said upper contact surface comprises a universal configuration wherein said upper contact surface is parallel with said central axis of said resiliently deformable elongated body

20. The method of claim 17, wherein said upper contact surface comprises three finger grip surfaces and two finger grip ridges.
